(19) United States
(12) Patent Application Publication
(10) Pub. No.: US 2008/0309131 A1
(43) Pub. Date: Dec. 18, 2008

(54) SEAT BACK STRUCTURE OF VEHICLE SEAT

(75) Inventors: Masaaki YOKOTA, Akishima-shi (JP); Atsushi Koike, Akishima-shi (JP); Yamato Higuchi, Akishima-shi (JP)

Correspondence Address: BROWDY AND NEIMARK, P.L.L.C.;624 NINTH STREET, NW, SUITE 300, WASHINGTON, DC, 20001-5303, US

(73) Assignee: Tachi-S Co., Ltd., Akishima-shi (JP)

(21) Appl. No.: 11/762,226

(22) Filed: Jun. 13, 2007

(51) Int. Cl. B60N 2/42; B60N 2/427

(52) U.S. Cl. 297/216.12

(57) ABSTRACT

In a seat back structure, an auxiliary frame having a headrest mounted thereon is provided independently of a seat back frame and movable via link element and guide element along a predetermined path with respect to the seat back frame. The guide element includes: a bracket having one end pivoted to the seat back frame; a guide hole formed in the bracket; and a guide pin provided to the seat back frame, the guide pin being slidably engaged in the guide hole. A buffer member is provided to another end of the bracket. Shortly after the headrest has been moved to a headrest receiving point in a rear-end collision case, the headrest is subjected to abrupt backward displacement under backward inertia of seat occupant, but, such abrupt backward displacement of headrest is decelerated by the buffer member.

### BACKGROUND OF THE INVENTION

1. Field of the Invention

The present invention relates to a seat back of vehicle seat with a movable headrest. In particular, the invention is directed to a structure of seat back of seat for vehicle which permits a headrest mounted in the seat back to be displaceable in forward and upward directions in response to a rear-end collision occurred to the vehicle.

2. Description of Prior Art

Among vehicle seats with headrest, there has been known a vehicle seat of such type that, responsive to a rear-end collision, a headrest mounted thereon is subjected to forward movement under a backward force of inertia applied from a lumbar part of the occupant and moved toward a head portion of occupant on the seat. For example, the Japanese Laid-Open Patent Publication No. 2001-26232 discloses the vehicle seat of this kind. According thereto, the seat back thereof includes a seat back frame and an auxiliary frame, such that a lower portion of the auxiliary frame is rotatably connected via a lower link with the seat back frame. A headrest is fixed on the top of the auxiliary frame to support a head of seat occupant, while a pressure receiving portion is provided in the lower region of the auxiliary frame at a point where a lumbar part of the seat occupant is positioned. Normally, the auxiliary frame is set at a given lower home position and the headrest is thus set at a lower home position. When a rear-end collision occurs, a backward load is applied to that pressure receiving portion from the seat occupant's lumbar part which is moved backwardly under a backward inertia of the seat occupant. Then, due to such backward load, the auxiliary frame is rotated in forward and upward direction relative to the lower link, which causes simultaneous forward and upward displacement of both headrest from the lower home position, thereby providing a quick support to the occupant's head and upper body portion.

In the foregoing conventional seat back structure, the auxiliary frame is movably supported by an upper guide pin and a lower link with respect to the seat back frame, such the upper guide pin is slidably engaged in a guide hole formed in the seat back frame, whereas the lower link is movably connected with the seat back frame. Due to such arrangement, the auxiliary frame and headrest are merely free to move either in a forward and upward direction or a backward and downward direction, along a given path, without any means for restricting the movement of the auxiliary frame itself. Thus, when a rear-end collision occurs, a head of seat occupant is certainly given a quick support by the forward and upward movement of the headrest, but, shortly after that emergency headrest support, the auxiliary frame is abruptly moved back, or moved in the backward and downward direction, under a backward inertia of the seat occupant's upper body portion, as a result of which, the headrest is also abruptly returned to the lower home position. Consequently, it is highly possible that the seat occupant's head will be abruptly inclined backwards to receive a great impact, and therefore, the seat occupant's head and neck portion will be seriously damaged. This requires an improvement of seat back structure to prevent such abrupt return of the auxiliary frame or headrest in order to protect the seat occupant's head and neck portion.

### SUMMARY OF THE INVENTION

In view of the afore-stated drawbacks, it is a purpose of the present invention to provide an improved seat back structure in a vehicle seat, which effectively prevent the above-discussed abrupt return of the auxiliary frame or headrest in the case of rear-end collision.

In order to achieve such purpose, a seat back structure in vehicle seat in accordance with the present invention is basically comprised of:
a seat back frame having an upper portion and a lower portion;
an auxiliary frame provided independently of the seat back frame, the auxiliary frame having an upper portion and a lower portion;
a headrest provided on the upper portion of the auxiliary frame;
a pressure receiving portion provided in the lower portion of the auxiliary frame;
a guide element provided between the upper portion of the seat back frame and the upper portion of the one auxiliary frame, the guide element including:
   a bracket having: an upper end portion; and a lower end portion pivotally connected with the seat back frame at a pivotal point, such that the upper end portion of the bracket is rotatable relative to the pivotal point associated with the lower end portion of the bracket;
   a rectilinearly elongated guide hole formed in the bracket; and
   a guide pin provided to the auxiliary frame, the guide pin being slidably engaged in the rectilinearly elongated guide hole;
a link element rotatably connected between the lower portion of the seat back frame and the lower portion of the auxiliary frame;
the auxiliary frame being displaceable relative to the seat back frame, along a predetermined path, through sliding movement of the guide pin along the rectilinearly elongated guide hole in conjunction with concurrent rotation of the link element, whereby the headrest is displaced between a home position where the headrest is normally set and an upwardly displaced point defined above the home position, wherein the upwardly displaced point is a point where the headrest is to receive a head of a seat occupant on the vehicle seat in case of rear-end collision,
a biasing means for giving a biasing force to the link element; and
a damper element provided to the upper end portion of the bracket,
with such an arrangement that, when the rear-end collision occurs, a first great load is applied from a lumbar part of the seat occupant to the pressure receiving element, thereby causing the auxiliary frame to displace upwardly to move the headrest toward the upwardly displaced point for receiving the head of the seat occupant, and shortly thereafter, upon a second great load being applied to the headrest from the head of the seat occupant in a direction backwardly of the seat back frame, the auxiliary frame is subjected to backward displacement to cause rotation of the upper end portion of the bracket relative to the pivot point so as to act on the damper element, so that the backward displacement of the auxiliary frame is decelerated by the particular damper element, which in turn decelerates backward displacement of the headrest in a direction backwardly of the seat back frame.

Other various features and advantages will become apparent from reading of the description hereinafter, with reference to the annexed drawings.

### BRIEF DESCRIPTION OF THE DRAWINGS

FIG. 1 is a plan view for generically showing a whole of seat back structure in a vehicle seat in accordance with the present invention;

FIG. 2 is a partly broken exploded perspective view of the seat back structure;

FIG. 3 is a longitudinally sectional view of the seat back structure, which explanatorily shows a home position of headrest and auxiliary frame, so that the back portion and head of seat occupant normally rests on the seat back and headrest, respectively;

FIG. 4 is a longitudinally sectional view of the seat back structure, which explanatorily shows the state where, responsive to a load from the lumbar part of seat occupant, the auxiliary frame and headrest are about to be displaced upwardly in a rear-end collision case;

FIG. 5 is a longitudinally sectional view of the seat back structure, which explanatorily shows how the auxiliary frame and headrest are displaced from their respective home positions, so that the headrest is displaced to an upwardly displaced point for receiving the seat occupant's head; and

FIG. 6 is a longitudinally sectional view of the seat back structure, which explanatorily shows how backward displacement of the auxiliary frame and headrest is decelerated by a damper member.

### DETAILED DESCRIPTION OF PREFERRED EMBODIMENTS OF THE INVENTION

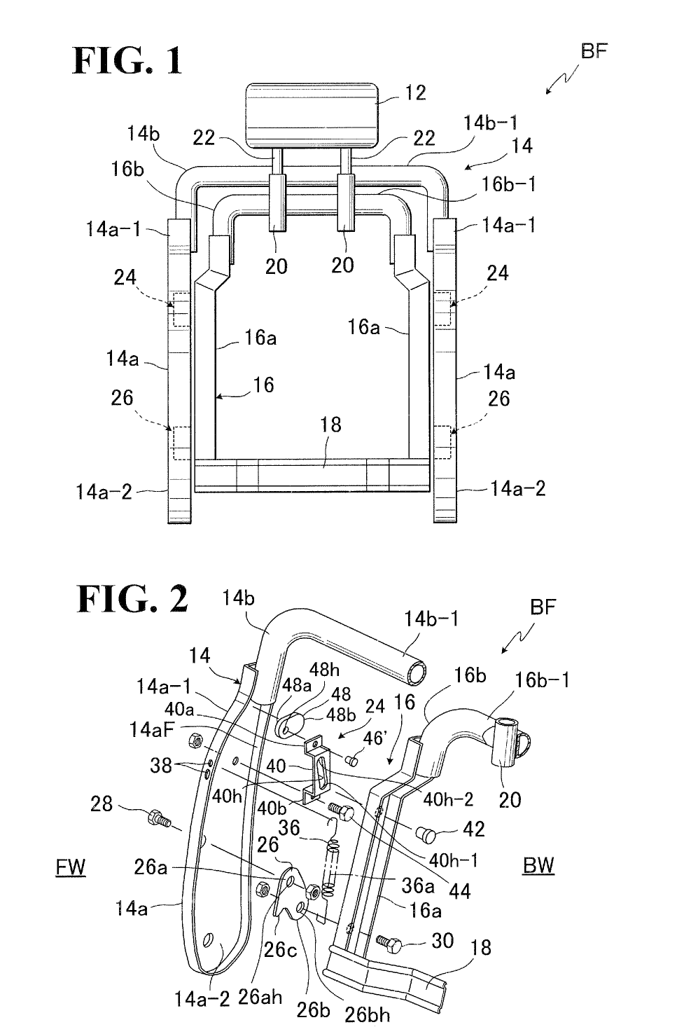

Referring to FIG. 1 through FIG. 6, there is illustrated one exemplary embodiment of seat back structure of vehicle seat in accordance with the present invention.

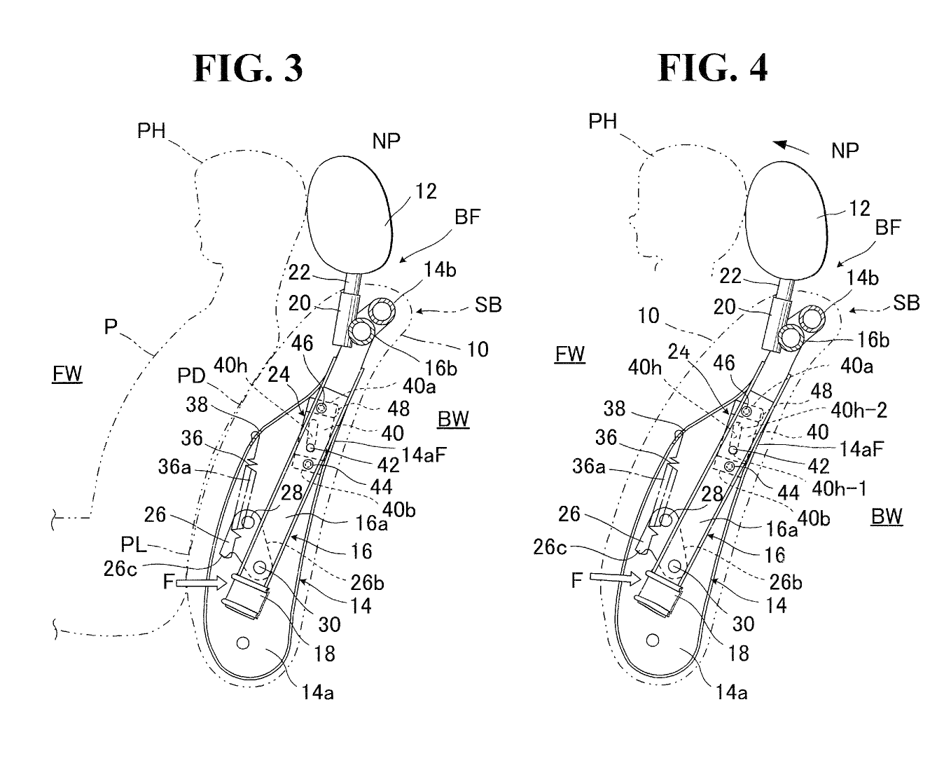

FIG. 1 shows a backrest framework (BF) which is upholstered as indicated by (10) to form a seat back (SB) as seen from FIG. 3. The backrest framework (BF) is basically composed of a seat back frame (14) and an auxiliary frame (16) disposed inwardly of the seat back frame (14). The seat back frame (14) is a generally “inverted U” shape comprising an upper frame member (14b) and a pair of lateral frame members (14a) (14a). The auxiliary frame (16) is also of a generally “inverted U” shape comprising an upper frame member (16b) and a pair of lateral frame members (16a) (16a). As shown in FIG. 1, a pressure receiving element (18) is firmly connected between the two lower end portions respective of the afore-said pair of side frame members (16a).

Designation (12) denotes a headrest provided on the auxiliary frame (16). Namely, the headrest (12) has a pair of headrest stays (22) (22), each being securely inserted in the respective pair of known cylindrical holders (20) (20) fixed to the horizontal top portion (16b-1) of the upper frame member (16b) of the auxiliary frame (16). As understandable from FIGS. 1 and 3, the headrest (12) is disposed above the top of the seat back (SB), while the auxiliary frame (16) itself disposed inwardly of and independently of the seat back frame (14).

The foregoing two-frame construction of seat back (SB), i.e. the combination of seat back frame (14) and auxiliary frame (16), is however known from the previously noted Japanese Laid-Open Patent Publication No. 2001-26232. Likewise as in such prior art, the auxiliary frame (16) is displaceable responsive to a rear-end collision so as to cause forward displacement of the headrest (12) toward a head of seat occupant. In brief, subject to a rear-end collision occurring, a backward inertia is generated at a seat occupant's lumbar part (designated by (PL) in FIG. 3), which applies a corresponding backward load (designated by (F) in FIG. 3) to the pressure receiving member (18), whereby the lower end portion of auxiliary frame (16) is displaced backwardly, while simultaneously, the headrest (12) is displaced toward a seat occupant's head (PH). But, this is not the subject matter of the present invention and any further description is omitted thereon.

In accordance with the present invention, as generically indicated in FIG. 1, an upper guide element (24) and a combination of lower rotatable link element (26) and displaceable biasing element (36) are arranged in the above-described conventional backrest framework (BF) so as to provide for controlled displacement of both auxiliary frame (16) and headrest (12) to serve the purposes of the present invention as will be elaborated.

As far as the FIG. 1 is concerned, briefly stated, the upper guide element (24) is provided between two upper frame regions respectively of the seat back frame (14) and auxiliary frame (16), whereas the lower link element (26) and biasing element (36) are provided between two lower frame regions respectively of the seat back frame (14) and auxiliary frame (16). In the shown embodiment, there are provided a pair of the upper guide elements (24) (24), a pair of lower link elements (26) (26), and a pair of biasing elements (36) (36). But, this is not imitative.

It should be noted that the term, “forward” or “forwardly”, refers to a side (FW) forwardly of the backrest framework (BF) or seat back (SB), whereas the term, “backward”, “backwards”, or “backwardly”, refers to a side (BW) backwardly of the backrest framework (BF).

Now, a specific description will be made of the seat back structure in the present invention.

For simplicity, a description will be made only of left-side half of the backrest framework (BF); namely, a left-side upper guide element (24), a left-side lower link element (26), and a left-side biasing element (36).

As seen in FIG. 2, the lower link element (26) may be a lower link member which is so formed to have: a first bearing hole (26ah) formed in a forward end portion (26a) thereof; a second bearing hole (26bh) formed in a backward end portion (26b) thereof; and a lug portion (26c) with which one end of the biasing element (36) is engaged. As best seen in FIG. 3, such lug portion (26c) is defined between the forward and backward end portions (26a) (26b) as well as at a point below and forwardly of the first bearing hole (26ha). The forward end portion (26a) is rotatably connected by a first pin or bolt (28) with an inward surface of the lateral frame member (16a) of the seat back frame (16), whereas the backward end portion (26b) is rotatably connected by a second pin or bolt (30) with an inward surface of the lateral frame member (16a) of the auxiliary frame (16). Precisely stated, as depicted in FIGS. 2 and 3, the forward end portion (26a) of lower link member (26) is rotatably pivoted via the first bolt (28) to the forward local area in an intermediate region of the side frame member (14a) associated with the seat back frame (14), wherein such intermediate region of side frame member (14a) is defined between the upper and lower regions (14a-1) (14a-2) of the side frame member (14a), as can be seen in FIG. 3. The backward end portion (26b) of lower link member (26) is rotatably pivoted via the second bolt (30) to the lower end region of the side frame (16a) associated with the auxiliary frame (16).

As shown in FIG. 2, the biasing element (36) may be an extension coil spring. One end of the extension coil spring (36) is securely engaged in securing holes (38) formed in a forwardly facing flange portion of the side frame member (14a). Hence, such one end of the extension coil spring (36) is situated right above and distant from the afore-said first bolt (28) associated with the lower link member (26), as can be seen in FIG. 3. Another end of the extension coil spring (36) is engaged with the lug portion (26c) of the lower link member (26), thereby giving a biasing force to the lower link member (26).

As best seen in FIG. 2, the upper guide element (24) may be comprised of: a guide bracket (40) having a rectilinearly enlongated guide hole (40h); a guide pin (42) slidingly engaged in such guide hole (40h); and a damper or buffer member (48) of elastic property provided between the guide bracket (40) and the lateral frame member (14a) of seat back frame (14).

More specifically, the guide bracket (40) has an upper end portion (40a) and a lower end portion (40b), and the guide hole (40h) is formed in a main body area of the guide bracket (40) between those upper and lower end portions (40a) (40b) so as to extend substantially along the longitudinal direction of the guide bracket (40). The lower end portion (40b) of guide bracket (40) is rotatably connected with the inward surface of upper region (14a-1) of seat-back-frame lateral frame member (14a) by means of pivot pin (42), as shown in FIG. 2. Thus, the guide bracket (40) as well as the upper end portion (40a) thereof are free to rotate relative to the pivot pin (42) at the lower end portion (40b) thereof.

The guide pin (42) is fixed in the upper region of the lateral frame member (16a) of auxiliary frame (16) so as to project outwardly therefrom. Such outwardly projected guide pin (42) is in a sliding engagement in the guide hole (40h) of guide bracket (40).

In this respect, as illustrated, both guide bracket (40) and guide hole (40h) extend vertically alongside of the auxiliary frame lateral frame member (16a) within the seat back (SB), so that the auxiliary frame (16) is displaceable along a predetermined path through sliding movement of the guide pin (42) along such vertical guide hole (40h) in conjunction with concurrent rotation of the lower link member (26) relative to the second bolt (30). This action in turn causes displacement of the headrest (12) between the home position (NP) and upwardly displaced point (UP), as will be described later.

The buffer member (48) has a forward end (48a) and a backward end (48b), and is formed with a hole (48h) in the forward end (48a) thereof. As illustrated, the forward end (48a) of buffer member (48) is securely connected, at the hole (48h) thereof, with the upper end portion (40a) of guide bracket (40) by means of a pin (46). It is observed that the backward end (48b) of buffer member (48) projects backwardly from that guide bracket upper end portion (40a), thus facing toward the backwardly facing flange portion (14aF) of lateral frame member (14a) of seat back frame (14). The buffer member (48) per se is in a slidable contact with the inward surface of upper region (14a-1) of seat-back-frame lateral frame member (14a).

Hence, both guide pin (42) and lower link member (26) are arranged in the above-described manner between the two lateral frame members (14a) and (16a) respectively of the seat back frame (14) and auxiliary frame (16).

FIG. 3 shows the state where the headrest (12) is set at the lower home position. Under such state, the lower link member (26) is retained by the extension coil spring (36) against rotation about the bolt (30), which in turn biasingly retains the auxiliary frame (16) at an initial position against movement, while biasingly causing the guide pin (42) to contact with the lower edge (40h-1) of guide hole (40h).

In this respect, it is to be seen that the first bolt (28) is a pivotal support point of the lower link member (26) with respect to the seat back frame (14), while the second bolt (30) is a pivotal support point of that lower link member (26) with respect to the auxiliary frame (16).

At the lower home position (NP) of the headrest (12) as in FIG. 3, it is observed that a central line or a line of force (36a) of the extension coil spring (36) is positioned at a point forwardly of the first bolt (28) which is a pivotal point of the lower link member (26) with respect to the seat cushion frame (16) as stated above. Under that condition, the lower link member (26) is biasingly caused by the extension coil spring (36) to rotate clockwise relative to the pivotal support point (at 28), whereby both auxiliary frame (16) and headrest (12) are resiliently and positively retained to their respective home positions, as shown in FIG. 3. While not shown, a proper stopper is provided to limit the clockwise rotation of the lower link member (26) so as to insure that the auxiliary frame (16) and headrest (12) are precisely positioned at their respective home positions shown in the FIG. 3.

It is noted here that the biasing force or contractive force of the extension coil spring (36) is set to such a degree at which the spring (36) will not be stretched by a load which is normally applied from a seat occupant's dorsal part (PD) to the backrest frame (BF) as well as a load normally applied from a seat occupant's lumbar part (PL) to the pressure receiving member (18).

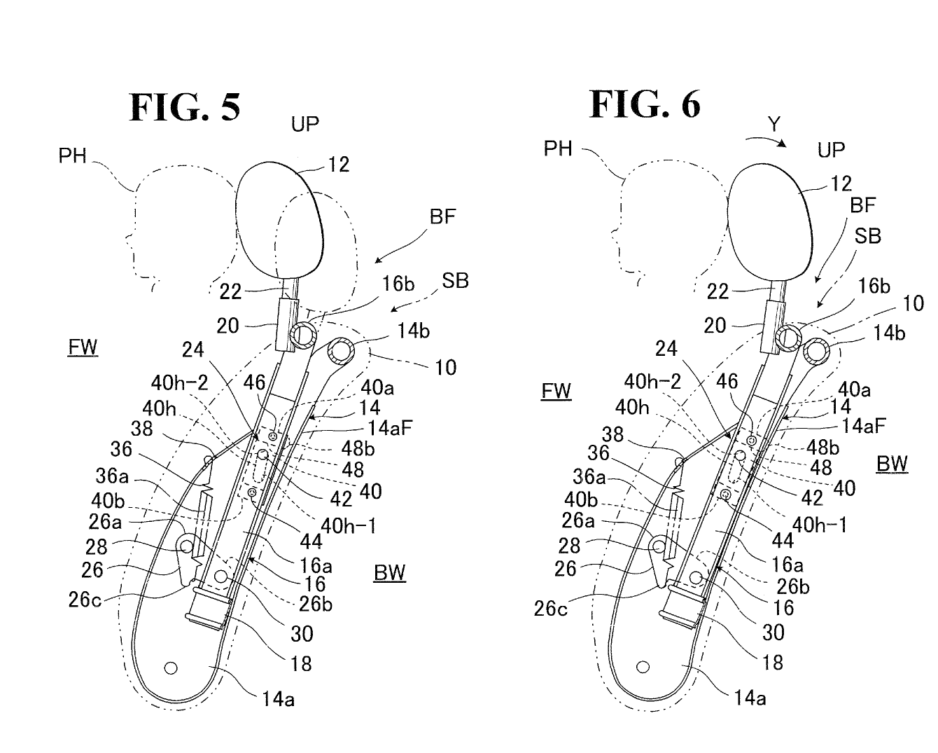

With the above-described arrangement, as indicated in FIG. 3, when a rear-end collision occurs, an excessive great backward load (F), which overcomes the biasing or contractive force of the extension coil spring (36), is applied to that pressure receiving element (18) from the seat occupant's lumbar part (PL) which is being moved backwardly under backward inertia of the seat occupant (P). Then, due to such great backward load (F), the lower link member (26) is rotated about the pivotal support point (at 28) anticlockwise, while simultaneously, the line of force (36a) of extension coil spring (36) is displaced from the home point forwardly of such pivotal support point (at 28) (see FIG. 4) toward another point backwardly of that particular pivotal support point (at 28) (see FIG. 5). As a result thereof, the biasing or contractive force of spring (36), which has been a clockwise biasing force as stated above, is now changed into an anticlockwise biasing force that assists in anticlockwise rotation of the lower link member (26), as understandable from FIG. 5, whereupon the auxiliary frame (16) is caused by such anticlockwise biasing force of spring (36) to displace forwardly and upwardly, which causes simultaneous forward and upward displacement of the headrest (12) from the lower home position (NP) toward an upwardly displaced point (UP) (or an emergency head support position). Simultaneous therewith, the guide pin (42) is slidngly moved in and along the guide hole (40h) upwardly from the guide hole lower edge (40h-2) and brought to contact with the guide hole upper edge (40h-1).

Thus, the auxiliary frame (16) is immediately displaced in forward and upward directions, along a predetermined path, due to the accelerated anticlockwise rotation of the lower link member (26) under the anticlockwise biasing force of extension coil spring (36) as well as to the rectilinear upward movement of the guide pin (42) along the guide hole (40h). With such controlled displacement of auxiliary frame (16), the headrest (12) is immediately displaced from the lower home position (NP) toward the upwardly displaced point (UP) for providing quick and stable support to the seat occupant' head (PH).

But, although the seat occupant's head (PH) is received and supported by the headrest (12) as such, an excessive backward inertia of the seat occupant (P), which is inevitably caused by the rear-end collision, creates and applies a great backward load to both of the headrest (12) and auxiliary frame (16), with the result that the headrest (12) is about to be abruptly inclined backwards from the emergency head support position (at UP), as indicated by the arrow (Y) in FIG. 6.

At this moment, however, in accordance with the present invention, the auxiliary frame (16) is displaced backwardly relative to the pivotal support point (at 30) at the backward end portion (26b) of lower link member (26), while being prevented against downward displacement under the anticlockwise biasing force of extension coil spring (36) whose line of force (36a) is disposed backwardly of the pivotal support point (at 28). With such backward displacement of auxiliary frame (16), a corresponding backward load is applied to the guide pin (42) in the guide hole (40h) of guide bracket (40) (the guide pin (42) is contacted with the guide hole upper edge (40h-2)), and therefore, the upper end portion (40a) of the guide bracket (40) is simultaneously rotated clockwise or backwardly relative to the lower pivot point (at the bolt 44), which in turn causes simultaneous backward movement of the damper member (48), so that the backward end (48b) of that particular buffer member (48) is immediately brought to contact with the flange portion (14aF) of the seat-back-frame lateral frame member (14a), as can be seen from FIG. 6.

Accordingly, the abrupt backward displacement of the auxiliary frame (16) is decelerated and slowly stopped due to a buffering effect of the foregoing buffer member (48), which means that the headrest (12) is slowly inclined in the backward direction, thereby insuring to protect the seat occupant's head (PH) as well as his or her neck portion against damage and injury. Further, at that time, the auxiliary frame (16) is also abruptly displaced downwardly due to the backward inertia and downward load or weight of seat occupant (P), but, such abrupt downward displacement of the auxiliary frame (16) is decelerated and slowly done under the anticlockwise biasing force of the extension coil spring (36) which attempts to give a counterforce against the downward displacement of auxiliary frame (16).

It is to be also appreciated that the above-described mechanism for changing the direction of biasing force of the biasing element (at 36) by displacing the line of force (36a) relative to the pivotal support point (at 28) is of a quite simplified structure and effective for rapid displacement of the headrest (12) to the emergency head support point (at UP).

While having described the present invention thus far, it should be understood that the invention is no limited to the illustrated embodiment, but, any modification, replacement and addition may be applied thereto without departing from the scopes of the appended claims.

What is claimed is:

1. A seat back structure in a vehicle seat, comprising:
a seat back frame having an upper portion and a lower portion;
an auxiliary frame provided independently of said seat back frame, said auxiliary frame having an upper portion and a lower portion;
a headrest provided on said upper portion of said auxiliary frame;
a pressure receiving portion provided in said lower portion of said auxiliary frame;
a guide element provided between said upper portion of said seat back frame and said upper portion of said one auxiliary frame, said guide element including:
a bracket having: an upper end portion; and a lower end portion pivotally connected with said seat back frame at a pivotal point, such that said upper end portion of the bracket is rotatable relative to said pivotal point associated with said lower end portion of the bracket;
a rectilinearly elongated guide hole formed in said bracket; and
a guide pin provided to said auxiliary frame, said guide pin being slidably engaged in said rectilinearly elongated guide hole;
a link element rotatably connected between said lower portion of said seat back frame and said lower portion of said auxiliary frame;
said auxiliary frame being displaceable relative to said seat back frame, along a predetermined path, through sliding movement of said guide pin along said rectilinearly elongated guide hole in conjunction with concurrent rotation of said link element, whereby said headrest is displaced between a home position where the headrest is normally set and an upwardly displaced point defined above said home position, wherein said upwardly displaced point is a point where the headrest is to receive a head of a seat occupant on said vehicle seat in case of rear-end collision,
a biasing means for giving a biasing force to said link element; and
a buffer element provided to said upper end portion of said bracket,
with such an arrangement that, when said rear-end collision occurs, a first great load is applied from a lumbar part of said seat occupant to said pressure receiving element, thereby causing said auxiliary frame to displace upwardly to move said headrest toward said upwardly displaced point for receiving the head of said seat occupant, and shortly thereafter, upon a second great load being applied to said headrest from the head of said seat occupant in a direction backwardly of said seat back frame, said auxiliary frame is subjected to backward displacement to cause rotation of said upper end portion of said bracket relative to said pivot point so as to act on said buffer element, so that the backward displacement of said auxiliary frame is decelerated by said particular buffer element, which in turn decelerates backward displacement of said headrest in a direction backwardly of said seat back frame.

2. The seat back structure as claimed in claim 1, wherein said buffer element is fixed to said upper portion of said bracket and arranged in said seat back frame in such a manner that, when said auxiliary frame is subjected to the backward displacement due to said rear-end collision, the buffer element is brought to contact with a part of said seat back frame, thereby decelerating the backward displacement of said auxiliary frame and said headrest.

3. The seat back structure as claimed in claim 1, wherein said link element has: a first pivotal point at which one end of the link element is pivotally connected with said seat back frame; and a second pivotal point at which another end of the link element is pivotally connected with said lower portion of said auxiliary frame, wherein said biasing means has a line of force therein and is connected between said link element and said seat back frame, with such an arrangement that, when said headrest is set at said home position, said line of force of said biasing means is positioned on one side of said first pivotal point, whereby the biasing means acts to biasingly retain both said link element and said auxiliary frame against movement, so that said headrest is retained at said home position, and that, when said first great load is applied to said pressure receiving portion, overcoming a biasing force of said biasing means, said link element is rotated to cause displacement of said line of force of said biasing means toward another side of said first pivotal point, whereby said auxiliary frame is biasingly caused by the thus-displaced biasing means to displace in a direction forwardly and upwardly of said seat back frame via said link element and said guide element, so that said headrest is moved from said home position to said upwardly displaced point.

4. The seat back structure according to claim 3, wherein said biasing means comprises an extension coil spring.
